(19) United States
(12) Patent Application Publication
(10) Pub. No.: US 2011/0254944 A1
(43) Pub. Date: Oct. 20, 2011

(54) SCANNING CHARGED PARTICLE MICROSCOPE

(76) Inventors: Tohru Ishitani, Hitachinaka (JP); Isao Nagaoki, Hitachinaka (JP)

(21) Appl. No.: 13/122,532

(22) PCT Filed: Oct. 2, 2009
(86) PCT No.: PCT/JP2009/005091

§ 371 Date: Jun. 27, 2011

(30) Foreign Application Priority Data
Oct. 6, 2008 (JP) 2008-259186

(51) Int. Cl. H04N 7/18; G06K 9/36

(52) U.S. Cl. 348/80; 382/280; 348/E07.085

(57) ABSTRACT

When a scanning image of a scanning charged particle microscope is impaired by an external disturbance, a disturbance frequency can be simply and precisely analyzed from the image in order to specify the external disturbance. The maximum frequency analyzable by the scanning charged particle microscope can also be increased up to several kHz, which is the rotation frequency of, for example, a turbo-molecular pump commonly used as an exhaust pump of the scanning charged particle microscope. In an FFT analysis of a stripe pattern which is an impairment of the scanning image, the scanning charged particle microscope performs a one-dimensional FFT (1D-FFT) in the Y-direction (sub-deflection direction of the charged particle beam) or a one-dimensional DFT (1D-DFT) in the X-direction (main deflection direction of the charged particle beam). To extend the analyzable maximum frequency up to several kHz, the scanning charged particle microscope also performs the 1D-FFT (or 1D-DFT) analysis in the X-direction (main deflection direction of the charged particle beam) along which the charged particle beam has a fast scanning speed.

### TECHNICAL FIELD

The present invention relates to a scanning charged particle microscope and, more particularly, to a scanning charged particle microscope enabling observation of surfaces of samples such as semiconductor devices and novel materials and equipped with a means for analyzing the vibration frequencies of external disturbances that impair scanned images of the microscope.

### BACKGROUND ART

Where an apparatus of scanning electron microscope (SEM) that is representative of a scanning charged particle microscope is installed in harsh external environments, the deflection of the electron beam relative to the sample is disturbed under the influence of the external disturbances and the images are impaired. Such a problem is disclosed in the cited reference 1.

Examples of typical external disturbances include mechanical vibrations arising from noises and the like and alternating magnetic fields from the outside. A typical SEM image suffering from disturbances is shown in FIG. 5(a1). The sample is a microscale sample of silicon (Si) material (the sample being constituted by repeating rectilinear flat convex regions and concave regions). Both ends of a convex region slightly tilted from the vertical axis (Y axis) of the image are observed as wavy stripe patterns due to disturbance vibrations.

In the prior art method, when the stripe patterns are simple, the period of the stripes has been counted in the Y-direction and the frequency has been calculated. Where the stripe patterns are complex, a power spectral image (also known as an FFT image) of a two-dimensional fast Fourier transform (hereinafter also referred to as a 2D-FFT) of its image (having a size of iₘₐₓ×jₘₐₓ pixels) as shown in FIG. 5(b1) has been utilized.

In the 2D-FFT image, the directions of the vertical axis (Y axis) and the lateral axis (X axis) are coincident respectively with the directions of the vertical axis and lateral axis in a real space. Physical quantities displayed by them are wave numbers (the numbers of waves per unit pixel length) providing a scale of a linear plot. The origin (f=0) of the wave numbers f [pixel⁻¹] falls on the central position of the image. The left and right ends of the X axis of the image correspond to waves f=−½ and f=+½ in the X direction, respectively. The lower and upper ends of the Y axis of the image correspond to waves f=−½ and f=+½ in the Y direction, respectively. In the power spectral image, bright regions are high-power (large-component) wave number regions. In FIG. 5(b1), bright regions correspond to the wave number regions of disturbance vibrations.

### CITATION LIST

### Patent Literature

Patent Literature 1: JP-A-10-97836

### SUMMARY OF INVENTION

### Technical Problem

The algorithm for identifying the wave numbers of disturbances by this 2D-FFT image analysis is complex because bright regions are broad and also dispersed in oblique directions. Furthermore, the identification accuracy is low. In addition, analyzable frequencies are normally restricted to hundreds of Hz or below.

It is an object of the present invention to analyze disturbance frequencies easily and accurately from a scanned image of a scanning charged particle microscope when the scanned image is impaired by external disturbances in order to identify the external disturbances. It is another object to increase the maximum analyzable frequency up to several kHz, which is a rotational frequency of turbomolecular pumps or the like often used as an evacuation pump for a scanning charged particle microscope.

### Solution to Problem

In an FFT analysis of a stripe pattern that is an impairment of a scanned image, in order to clearly and accurately find the disturbance frequencies, a one-dimensional FFT (1D-FFT) is performed in the Y direction (auxiliary deflection direction of a charged particle beam) or a one-dimensional DFT (1D-DFT) is performed in the X direction (main deflection direction of the charged particle beam). To extend the maximum analyzable frequency up to several kHz, a 1D-FFT (or 1D-DFT) analysis is performed in the X direction (main deflection direction of the charged particle beam) along which the charged beam is scanned at a high scanning speed.

### Advantageous Effects of Invention

According to the present invention, a scanning charged particle microscope can be offered which enables the vibration frequencies of external disturbances to be identified easily and accurately from a scanned image. Furthermore, the vibration frequencies can be analyzed up to a high-frequency range of several kHz.

### BRIEF DESCRIPTION OF DRAWINGS

FIG. 1 is a flowchart of a method of analyzing image vibrations in a scanned image of charged particles in accordance with the present invention.

FIG. 2 is a flowchart of a subroutine “computation and image display of normalized power spectral image data”.

FIG. 3 is a flowchart of a subroutine “computation and graphical representation of graphical data of an average power spectrum”.

FIG. 4 is a schematic block diagram of a scanning electron microscope of the present invention.

In FIG. 5, (a1) is an SEM image for analysis; (b1) is a 2D-FFT power spectral image of the image (a1); (a2) is an SEM image for analysis obtained by rotating the image (a1) clockwise by 90 degrees; (b2) is a Y-direction 1D-FFT power spectral image of the image (a2); and (b3) is an X-direction average graph of the Y-direction 1D-FFT power spectrum of the image (b2).

In FIG. 6, (a1) is an SEM image for analysis; (b1) is an X-direction 1D-FFT power spectral image of the image (a1); and (b2) is a Y-direction average graph of an X-direction 1D-FFT power spectrum of the image (b1).

In FIGS. 7, (a1), (a2), (a3), and (a4) are SEM images for analysis having image sizes of 256×256, 128×256, 256×128 and 128×128 pixels, respectively; and (b1)-(b4) are X-direction 1D-FFT power spectral images corresponding respectively to the SEM images (a1)-(a4) for analysis.

FIG. 8 is identification of disturbance frequencies using a 1D-FFT normalized power spectral image.

FIG. 9 is identification of disturbance frequencies using a 1D-FFT normalized power spectral graph.

In FIG. 10, (a1) is an analysis image; (b1) is a window screen for setting the wave numbers of the start and end of a passband using an FFT normalized power spectral image; (b2) is a window screen for setting the wave numbers of the start and end of a passband using a power spectral graph; and (a2) is a real-space image obtained by inverse FFT.

FIG. 11 is a graph of the dependence of power P(fₚ) on scan rotation angle θ.

FIG. 12 is a normalized power spectral graph in which a threshold value power spectrum (displayed by a broken line) is written.

In FIG. 13, (a1) is an analysis image; (b1) is a display screen in which a normalized power spectral image is masked; and (b2) is a display screen in which a normalized power spectral graph is masked.

FIG. 14 is a management master computer connected with plural SEMs via a network.

### DESCRIPTION OF EMBODIMENTS

Embodiments of the present invention are hereinafter described by referring to the drawings. Although, in the following embodiments, embodiments of a scanning electron microscope (SEM) are described, the invention is not limited to them. Similar advantageous effects can be obtained with a scanning transmission microscope (STEM) or a scanning ion microscope (SIM).

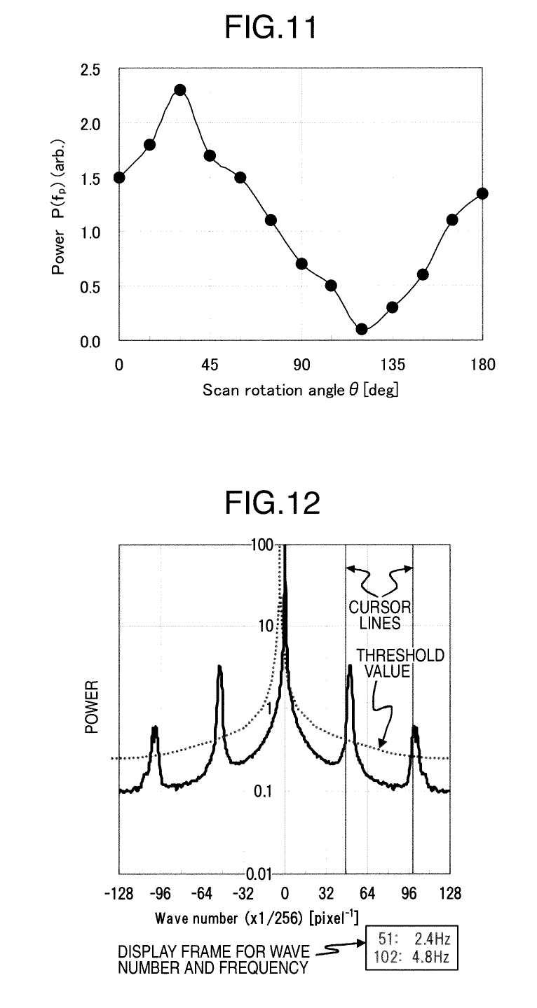

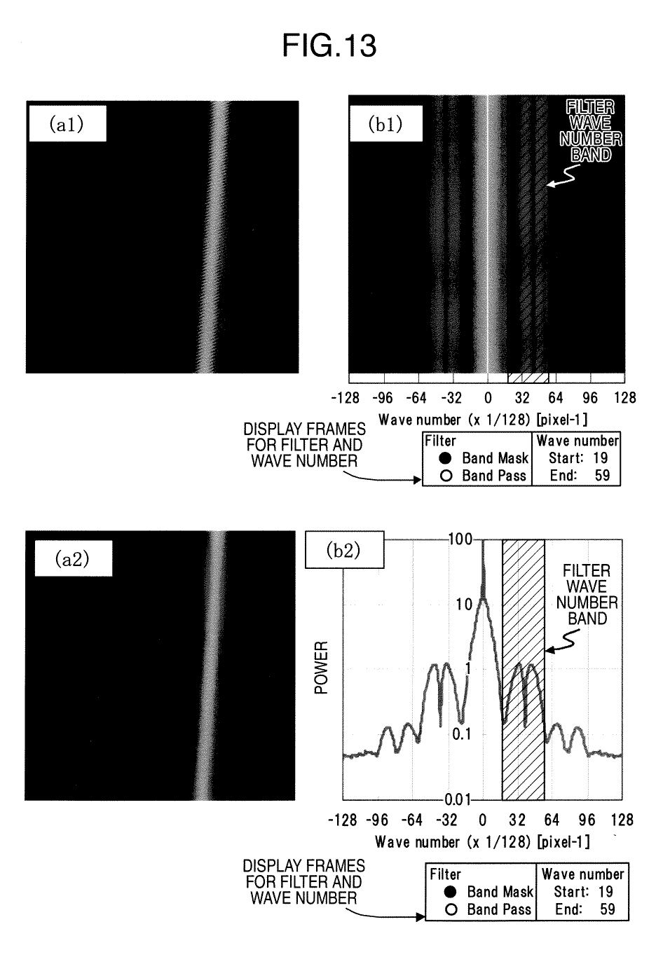

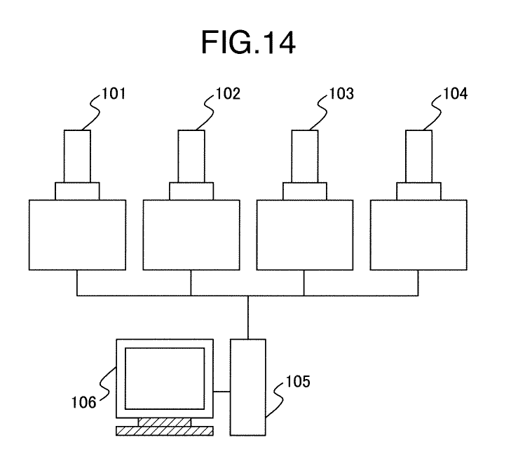

As an embodiment of the present invention, a scanning electron microscope (SEM) that is a typical example of scanning charged particles is shown in FIG. 4. Electrons 2 emitted from an electron gun 1 are focused onto a sample 5 by a condenser lens 3 and an objective lens 4 and scanned by a deflector 6. Secondary particles (such as secondary electrons) 7 are emitted from the sample 5 and detected by a charged particle detector 8. A control processor 9 including a computer conducts electrical control of the electron gun 1, the condenser lens 3, the objective lens 4, the deflector 6, the charged particle detector 8, the sample 5, and so on. A display means 10 displays a control window for conducting the electrical control, a scanned image, and so forth. A one-dimensional (1D) FFT analysis means 11 is within the control processor 9 including the computer. Information about the results of analysis is displayed by the display means 10.

### Embodiment 1

First, a method of finding a disturbance frequency fₕ in Hz (=s⁻¹) from an image is described.

FIG. 5 (1a) is an analysis image (having a size of 256×256 pixels) created by copying a part of an original SEM image (having a size of 640×480 pixels and a frame scan time of 40 s) when an external disturbance exists. The sample is a microscale of Si material whose cross section is machined into repeating rectangular wave shapes.

The sample can be other than the microscale. When a sample having a vertical end surface is used, the edge portions look bright and disturbances can be clearly seen from the image. The vertical end surface narrows the peak width of a distribution of intensities of secondary electron emission for the vertical direction and thus improves the contrast of a high-density stripe pattern.

Taking the direction of the main deflection in which the scanning speed is high as the X direction, stripe patterns are superposed on bright portions of the left and right end portions of a rectangular scale in the Y direction. A disturbance wave number fₚ [pixel⁻¹] is found by finding the period of this stripe pattern in the Y direction. A conversion of the disturbance wave frequency fₕ in Hz (=s⁻¹) can be computed using the beam scanning speed V_{Y} [pixel/s] from the equation below. Here, the beam scanning speed V_{Y} is a quantity determined from conditions under which the image is taken.

fₕ [Hz]=fₚ [pixel⁻¹]×V_{Y} [pixel/s] (1)

In the conventional method, the disturbance wave number fₚ [pixel⁻¹] has been computed by directly counting the number of stripes per pixel in the SEM image or from a power spectral image (see FIG. 5(b1)) of a two-dimensional FFT of the image.

In the present invention, the disturbance frequency fₕ [Hz] is identified using a power spectral image of 1D-FFT.

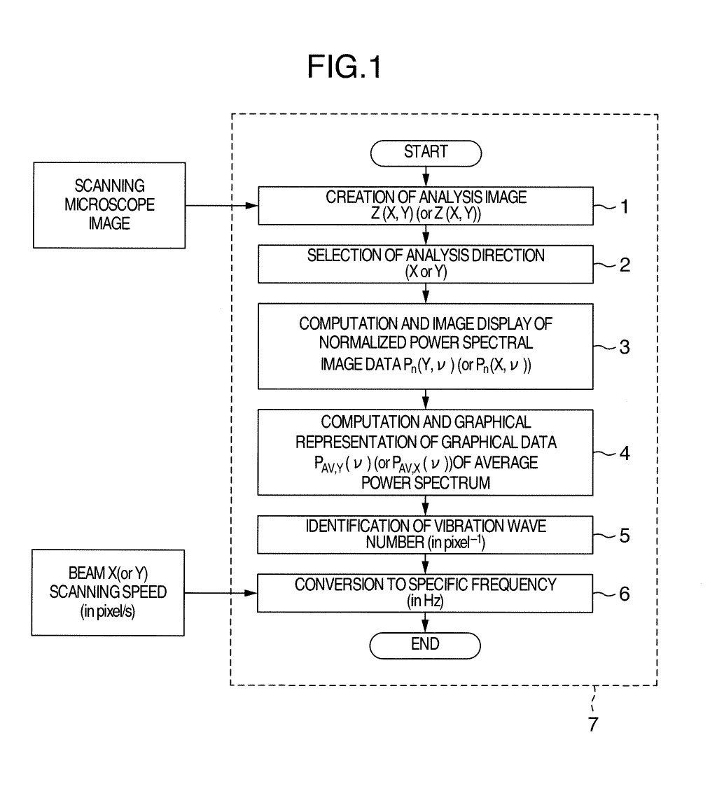

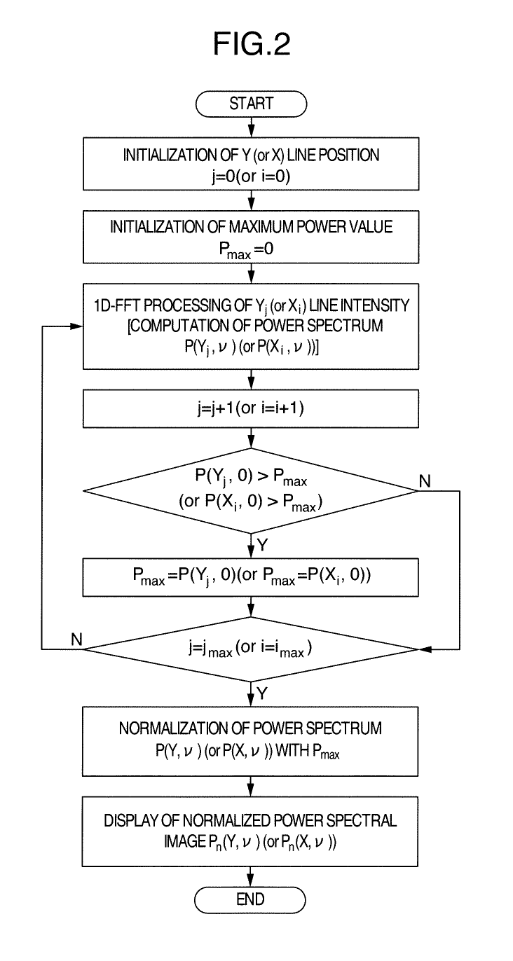

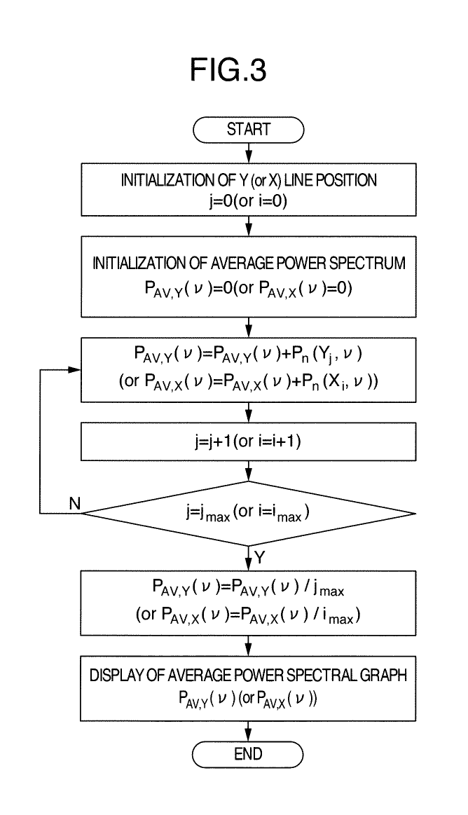

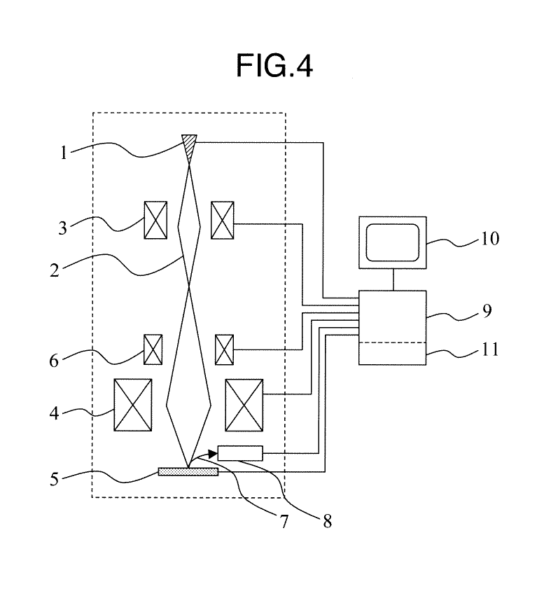

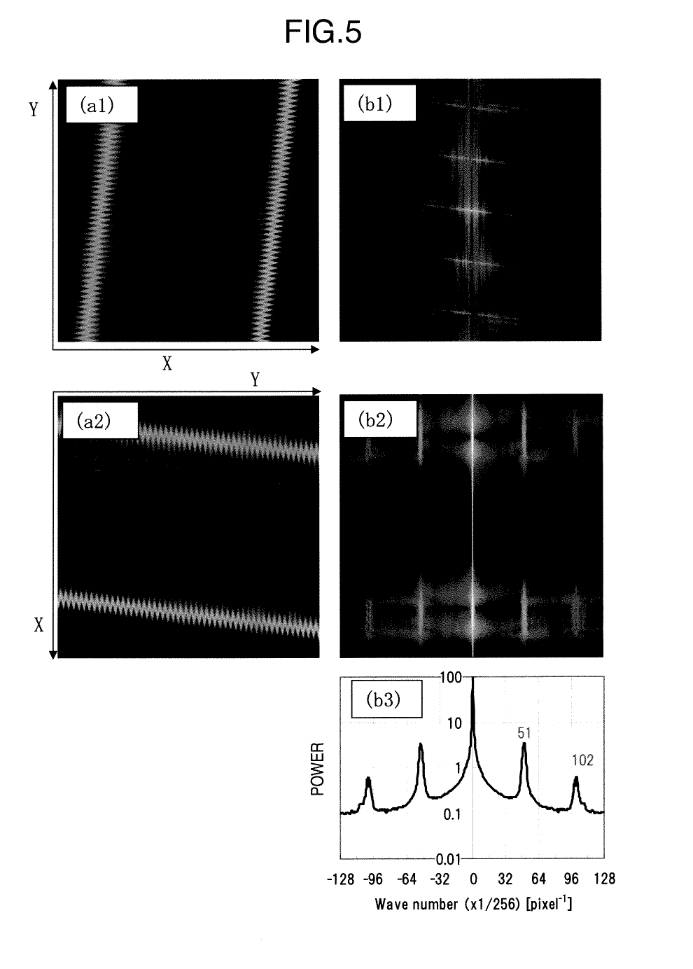

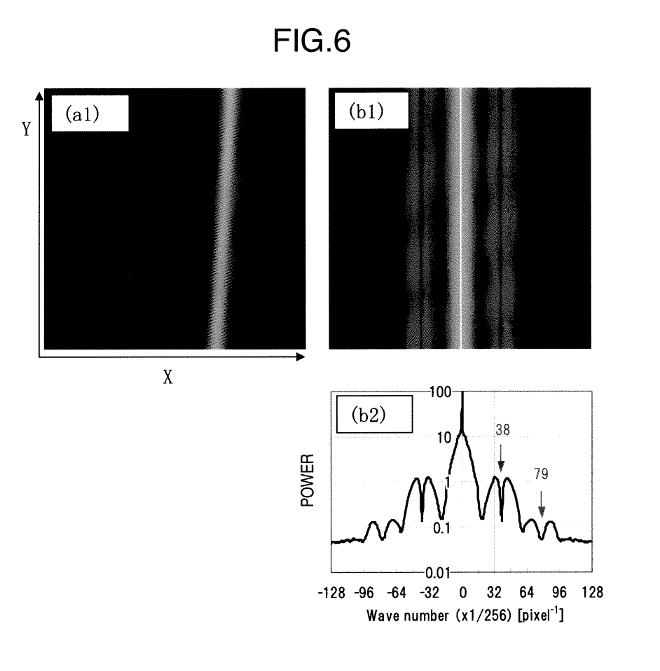

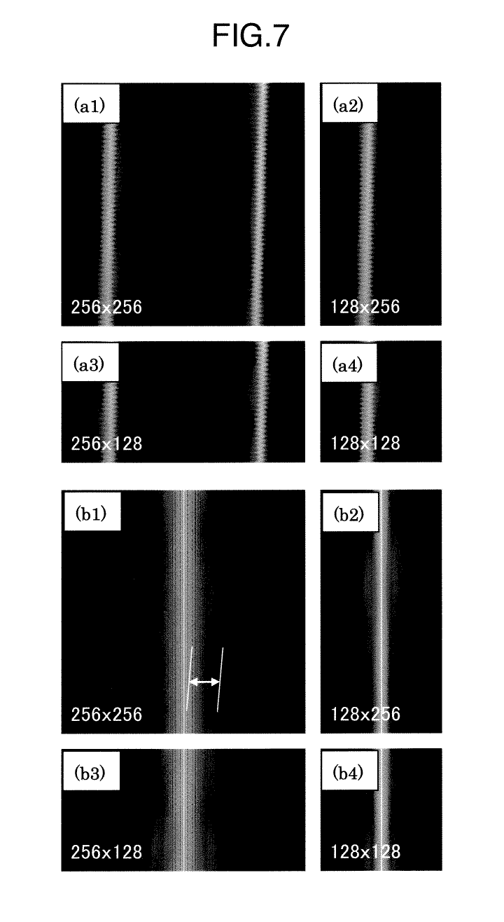

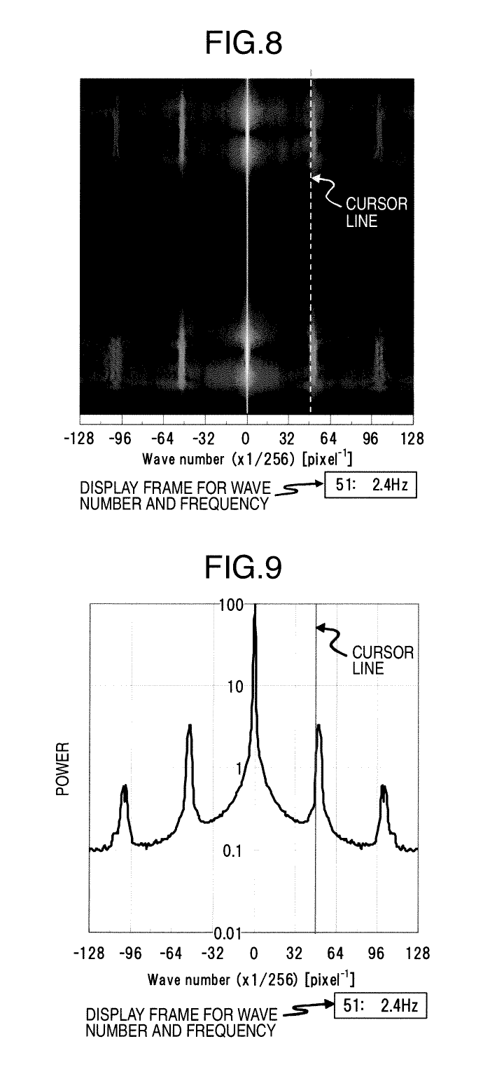

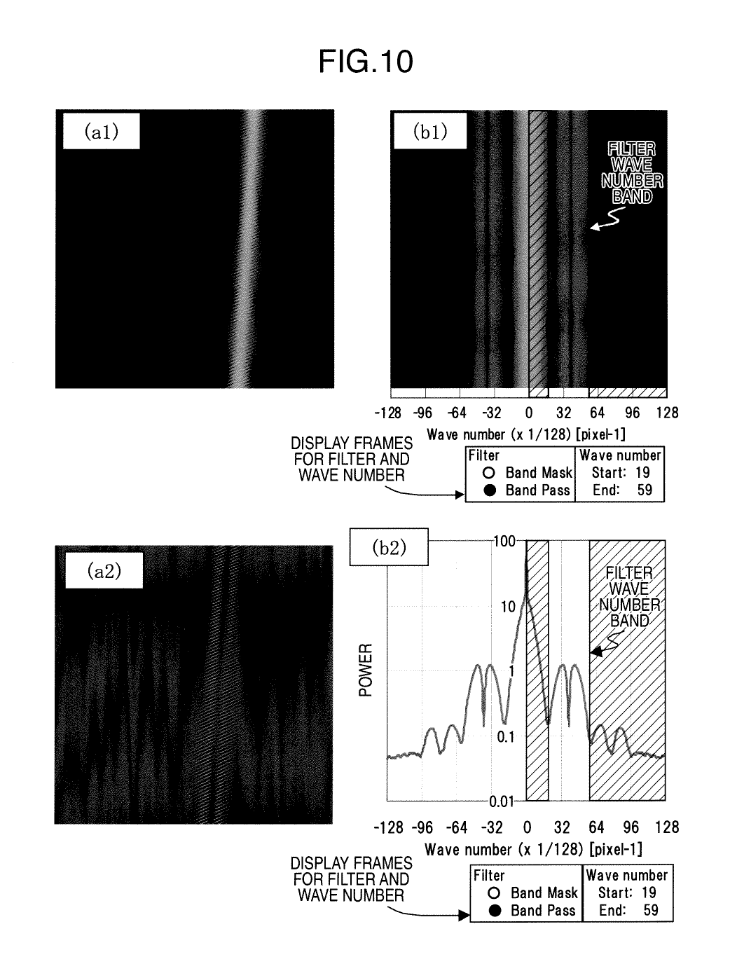

A flowchart for this is shown in FIG. 1. Details of Step 3 “computation and image display of normalized power spectral image data” and Step 4 “computation and graphical representation of graphical data of an average power spectrum” in FIG. 1 are illustrated as subroutines in FIGS. 2 and 3, respectively. The identification of the disturbance frequency is carried out by the 1D-FFT analysis means 11. An embodiment for identifying the disturbance frequency fₕ [Hz] of the analysis image (FIG. 5(a1)) using a power spectral image of Y-direction 1D-FFT is described hereinafter.

### Step 1: Creation of Analysis Image

FIG. 5(a2) is an image (having a size of 256×256 pixels) obtained by rotating the analysis image (FIG. 5(a1)) clockwise by 90 degrees for the sake of illustration. Rotating clockwise by 90 degrees is for ease of analysis using software and is not always necessary. The Y-axis direction of the SEM image is in the horizontal direction on the paper of FIG. 5(9a2) being a rotated image. The pixel intensity of the SEM image at each pixel position (Xᵢ, Yⱼ) is represented by Z (Xᵢ, Yⱼ; i (or j)=0, 1, . . . , iₘₐₓ (or jₘₐₓ), iₘₐₓ (Or iₘₐₓ)=256).

### Step 2: Selection of Analysis Direction (X or Y)

In the present embodiment, the Y direction is selected.

### Step 3: Computation and Image Display of Normalized Power Spectral Image Data Pₙ(Y, ν) (or Pₙ(X, ν))

A Y-direction 1D-FFT power spectrum is calculated from the pixel intensity Z(Xᵢ, Yⱼ: j=0, 1, . . . , jₘₐₓ) at each Xᵢ position. FIG. 5(b2) is a normalized power spectral image of its 1D-FFT. The vertical axis is the X axis in the same real space as the analysis image, the lateral axis is the wave number f (×1/jₘₐₓ) [pixel⁻¹] of the power spectrum, and the image brightness is a logarithmically represented 1D-FFT normalized power. In the image display (8-bit gray color display), the normalized power is logarithmically converted and the brightness and contrast of the image are corrected such that the minimum and maximum values become 0 and 255, respectively. In this power spectral image, the center of the lateral axis is the origin of the wave number f and the positive and negative portions of the image are symmetrical with respect to the wave number. The power spectral image is displayed on the display means 10.

### Step 4: Computation and Graphical Representation of Graphical Data P_{AV, Y}(ν) (or P_{AV, X}(ν)) of an Average Power Spectrum

The above-described Y-direction 1D-FFT normalized power spectrum is averaged in the X direction to compute an average power spectrum. FIG. 5(b3) is its graph.

### Step 5: Identification of Vibration Wave Number (in Pixel-1)

Since the positive and negative portions of the average power spectrum are symmetrical with respect to the wave number, identification of the frequency of the disturbance wave number fₚ [pixel⁻¹] is described using wave numbers on the positive side. In the graph of the average power spectrum (see FIG. 5(b3)), the disturbance wave number fₚ [pixel⁻¹] corresponds to spectral peak positions 51 and 102 (×1/256). The Y-direction beam scanning speed V_{Y} is calculated from the following equation to be V_{Y}=12 [pixel/s], using the Y width (480 pixels) of the original SEM image and the frame scan time of 40 s.

V_{Y} [pixel/s]=number of pixels in Y width of original SEM image/frame scan time [s] (2)

### Step 6: Conversion to Specific Frequency (in Hz)

The disturbance frequency fₕ can be converted to 2.4 and 4.8 Hz using Eq. (1). A vibration of 2.4 Hz corresponds to twice of the period of a vibration of 4.8 Hz. As can be seen from comparison between the 1D-FFT image (FIG. 5(b2)) of the present invention and the conventional 2D-FFT image (FIG. 5(b1)), the disturbance frequency is expressed in the state of stripes that are narrow in the vertical direction in the former so that it is easy to identify the disturbance frequency and its accuracy can be enhanced.

Such a disturbance frequency can be displayed on a display device to inform users.

### Embodiment 2

A 1D-FFT analysis in the X direction (main deflection direction of the charged-particle beam) is next described.

An embodiment of an X-direction 1D-FFT analysis using the same microscale sample as in Embodiment 1 is described. Using the total number of pixels (640×480 pixels) of the original SEM image and the frame scan time (40 s), the X-direction beam scanning speed V_{X} is calculated to be V_{X}=7680 [pixel/s] from the following equation:

V_{X} [pixel/s]=total number of pixels of original SEM image/frame scan time [s] (3)

FIG. 6(a1) is an SEM image (having a size of 256×256 pixels) where there are external disturbances. FIG. 6(b1) is an X-direction 1D-FFT normalized power spectral image. FIG. 6(b2) is a graph created by performing averaging of the power spectrum in the Y direction. In this X-direction 1D-FFT graph, disturbance vibrations appear as adjacent twin peaks and the disturbance wave numbers to be identified correspond to the wave numbers of the valley positions between the twin peaks. The microscale ends vibrating at a high wave number f can be regarded as repeating vibrations of cases where one approaches the scanning beam and in a case where one moves away from the scanning beam. As a result, the wave numbers detected with the scanning beam are ones which are slightly higher and lower than f, forming twins. The identified disturbance wave numbers are fₚ [pixel⁻¹]=38 and 79 (×1/256). Using an X-direction beam scanning speed V_{X}=7,680 [pixel/s] and the equation below, the disturbance frequency fₕ [Hz] can be identified as fₕ=1,140 and 2,370 Hz. The former corresponds to the vibration frequency of twice of the period of the latter.

fₕ [Hz]=fₚ [pixel⁻¹]×V_{X} [pixel/s] (4)

In an analysis image of an X-direction 1D-FFT analysis, it is desirable to create it in such a way that only one of the left and right ends of the microscale is contained, because waves forming stripe patterns at individual ends are usually not in phase with each other between the left and right ends. That is, it is desired that two or more disturbances be not contained in the direction in which an analysis is made.

The X direction is the main deflection direction of the beam scanning. The beam scanning speed V_{X} is higher than the Y-direction scanning speed V_{Y} by a factor of as many times as the number of pixels in the Y width of the original SEM image. A change by a factor of 200 in reduction of the frame scan time from 40 s to 0.2 s results in an increase by a factor of 200 in V_{X} and V_{Y}. 1D-FFT analyses in the X and Y directions using SEM images in various frame scan times make it possible to analyze disturbance frequencies, respectively, of hundreds of Hz or lower and hundreds of Hz or higher. The maximum analyzable frequency is about 10 kHz or higher as a result of X-direction 1D-FFT. As a consequence, disturbance vibrations, for example, caused by a turbomolecular pump (having a rotational speed of thousands of revolutions per second) can be analyzed easily and accurately.

Around an SEM apparatus there exist factors of disturbance vibrations possessed by the apparatus itself such as mechanical resonant vibration frequencies, periodic motions such as by the turbomolecular pump, and electrical frequencies of a control power supply. When an SEM apparatus is installed under environments where disturbances such as floor vibrations and disturbance external magnetic fields have been suppressed and disturbance vibrations are analyzed from analysis images of a specific sample (for example, a microscale sample) under prescribed SEM observation conditions (such as electron irradiation energy, beam current, focusing conditions, observation magnification, and image scanning frame time), the disturbance vibration frequencies and their power values (magnitudes of the vibrational components) of the apparatus itself under normal SEM operating conditions are obtained. Since the disturbance vibration frequencies and their power values of the apparatus itself vary according to the environment where the SEM apparatus is installed, analysis of disturbance vibrations is performed and they are recorded in the control processor 9 together with information about the installation environment whenever the installation environment varies. In later analysis of disturbance vibrations (where the same specific sample as in the prescribed SEM observation conditions is adopted), the identified disturbance vibration frequencies and their power values can be compared with the recorded natural vibration frequencies of the apparatus and their power values and can be displayed. Where a new disturbance vibration frequency appears or where power values of the known disturbance vibration frequencies exceed specified tolerable values, their occurrences are displayed on the display device.

### Embodiment 3

FIGS. 7 (a1), (a2), (a3), and (a4) are examples of SEM image for analysis, having image sizes of 256×256, 128×256, 256×128 and 128×128 pixels, respectively. FIGS. 7(b1)-(b4) are their X-direction 1D-FFT power spectral images, respectively. In FIGS. 7(b1)-(b4), all the images show substantially identical power spectra. In the 1D-FFT analysis of the present invention, once the size in the direction of the 1D-FFT is set to 2^{m} pixels (integer m is 5 to 10 in practical applications), the size in the remaining direction may be arbitrary; a rectangular form of vertically long or laterally long or even a square can be analyzed. The S/N ratio of the power spectra can be improved by adjusting the shape or the size of the analysis image such that stripe patterns are contained at a large proportion. (In a 2D-FFT analysis of the conventional method, the image size is normally restricted to squares of 2^{m} (m=5 to 10) pixels.) For example, if the size of the original SEM image is 512×512 pixels and thus the image size in the 1D-FFT direction satisfies 2^{m} pixels (m=5 to 10) conditions, then the whole original image may be treated as an analysis image.

Incidentally, discrete Fourier transform (DFT) can also be used. The relationship between fast Fourier transform and discrete Fourier transform is now described.

Fast Fourier transform (FFT) is a technique for performing a transformation at high speed by taking notice of the symmetry of discrete Fourier transform (DFT) and reducing the amount of computation. In a DFT with period N, the multiplication operations of complex numbers are N² times. In contrast, in FFT, the number can be reduced to N·log₂ N/2. Where N is a power of 2, i.e., 2ⁿ, the ratio of the numbers of the multiplication operations is given by the following equation. The larger m (that is, N) is, the greater the reducing effect is.

[FFT]/[DFT]=m·2^{m-1}/2^{2m}=m/2^{m+1}

For example, when N=64, 128, 256, and 512, the above ratio is 0.047, 0.027, 0.016, and 0.0088, respectively. In DFT, the condition of FFT N=2ⁿ does not hold and the processing time is prolonged.

If DFT is adopted instead of FFT, there arises the advantage that the shape and size of analysis images can be set at will in such a way that stripe patterns are contained at a larger proportion without the image size being restricted to 2ⁿ (m=5 to 10) pixels. However, there is the disadvantage that the processing time for Fourier transform is increased. Where an analysis image of a large size needs to be processed at high speed, FFT is used. In Embodiments 1 and 2 described so far and in the following Embodiments 4 to 7, examples using FFT are given. If DFT is used, results equivalent to those with FFT are obtained under the aforementioned features of advantage and disadvantage.

### Embodiment 4

An identifier (operator of the apparatus) can identify the disturbance frequencies while visually checking the image and graph of the 1D-FFT normalized power spectrum displayed on the display means 10. FIGS. 8 and 9 are the image and the graph, respectively. A wave number axis similar to that of the graph of FIG. 5(b3) is displayed at the bottom of the image to the same scale as the wave numbers of the image. A vertical cursor line superposed on the image can be moved by the identifier into an arbitrary wave number position using a mouse or arrow keys (← and ←) on a keyboard. The wave number [×(1/iₘₐₓ) or ×(1/jₘₐₓ) pixel⁻¹] at the position of the cursor that is in motion or at rest and frequency (Hz) are arrayed left and right and displayed within a display frame for wave number and frequency under the right end of the wave number axis. The identifier can identify a disturbance frequency by placing the cursor at the position of a disturbance wave number on the image or the graph.

### Embodiment 5

An embodiment for identifying the amplitude and its vibration direction in addition to the wave number of a disturbance vibration is described. The magnitude of the amplitude of the disturbance wave number can be evaluated by the magnitude of a 1D-FFT power. A specific amplitude value (in units of length) in a real space is computed by the following method. (1) In an FFT normalized power spectral image or power spectral graph, a bandpass filter that passes a wave number passband associated with the disturbance wave number is set. (2) The power spectrum passed through the bandpass filter is subjected to inverse FFT and a real-space image of a stripe pattern formed by the passband wave numbers is created. (3) The width of the stripe pattern is measured along the axis of the direction of the 1D-FFT. (4) The width (in pixels) of the stripe pattern is multiplied by the pixel size (for example, in nm/pixel) of the analysis image to obtain an amplitude value (for example, in nm). The 1D-FFT analysis means 11 has the function of the 1D-FFT inverse transform together with the 1D-FFT function.

FIG. 10(a1) is an analysis image, (b1) is a window screen for setting the wave numbers of the start and end of the passband using an FFT normalized power spectral image, (b2) is a window screen for setting the wave numbers of the start and end of the passband using a power spectral graph, and (a2) is a real-space image obtained by inverse FFT. “Band Pass” is selected from the filter display frame under the window screen of FIG. 10(b1) or (b2) using a radio button. The wave numbers of the passband are set by the wave number of the start and the wave number of the end of the bandpass filter on which semitransparent masks are not placed in each spectral image or spectral graph. The wave number of the start and the wave number of the end can be selected and held by clicking the left or right end of the mask with the mouse and can be moved into an arbitrary wave number position by moving the mouse left or right or entering an arrow key on the keyboard (note that the moving end cannot pass over the other end). The wave numbers of the start and the end are displayed within the wave number-displaying frame, including when in motion. Since the power spectrum is symmetrical with respect to the vertical axis at the origin of wave numbers, a passband is automatically set by computer processing if the setting of the wave numbers of the passband is done in a region where wave numbers have a positive sign even in a band where wave numbers have an inverse sign. In the present embodiment, “31” that is a main disturbance wave number (×(1/256) pixel⁻¹) is noticed and a wave number band containing it is “19-51”.

The vibration direction of a specific wave number is next identified by the following procedure. (1) The rotation angle θ of the beam scanning is varied in steps (for example, in steps of 15 degrees within a range of 0=0 to 180 degrees) in synchronism with a sample for observation of disturbances and an SEM image is acquired at each rotation angular position. Note that the angle of deviation between the X axis of the coordinates of the sample and the direction of the main beam deflection (X axis direction) (at θ=0) is stored as a correction angle θo. (2) An FFT power spectral graph of an analysis image is created for each SEM image. (3) A power P(fₚ) at a wave number fₚ of interest of the power spectral graph is plotted with respect to the rotation angle θ, thus creating a graph. (4) In this graph, a direction given by adding the correction angle θo to a rotation angle θₘ at which the power value is maximized is a vibration direction of the wave number of interest (the positive and negative directions are not discriminated from each other). FIG. 11 is a graph of the dependence of the power P(fₚ) on θ. Where a disturbance at the wave number fₚ=38 (×1/256 pixel⁻¹) appears as twin peaks as shown in FIG. 10(b2), the P(fₚ) value is the average value of the twin peak values. The graph shows that θₘ≅30 degrees and the vibration direction of the disturbance at the wave number fₚ is identified to be an azimuthal direction of 30 degrees+θo. In this method of identification, there is an assumption that the effects of rotation of the sample on the disturbance can be neglected. On this assumption, it can be judged that the disturbance factor of a power P(fₚ) having low dependence on θ accompanies a scanning rotation signal.

### Embodiment 6

An example of analysis of diurnal transition of an SEM apparatus under disturbance vibration environments is next described. First, (1) the control processor 9 periodically (for example, every specified day of the week) acquires an SEM image of a specified sample (for example, a microscale sample) under specified SEM image observation conditions and creates an analysis image. (2) A normalized power spectral image and a normalized power spectral graph of the analysis image are created. (3) These images and graphs are stored in the control processor 9. (4) When required, these stored images and graphs can be displayed on the display means 10 together with time transition information. The manner in which images are displayed can be selected from display of each individual image, display of plural images arranged side by side, and overlapped display of plural images successively with small downward shifts. On the other hand, display of graphs can be selected from display of each individual graph and display of plural overlapped graphs. Furthermore, a diurnal transition plot display of the power P(fₚ) at a specific wave number can also be provided.

In analysis of a diurnal transition under the disturbance vibration environments, a threshold value power spectrum can be set beforehand in a power spectrum of a normalized power spectral graph. When a wave number at which the power spectrum exceeds the threshold value appears, its occurrence can be displayed on the display means 10 or stored in the control processor 9. FIG. 12 is a normalized power spectral graph in which a threshold value power spectrum (displayed by a broken line) is written. The control processor 9 finds disturbance wave number peaks at two positions of wave numbers 51 and 102 (×1/256) [pixel⁻¹] in the normalized power spectrum and draws cursor lines there. The two wave numbers and corresponding disturbance frequencies (in Hz) are displayed within the display frame for wave number and frequency. The control processor 9 judges that the normalized powers at these disturbance wave numbers are in excess of the threshold values and displays in red the numerical values within the display frame for wave number and frequency (where the threshold value is not exceeded, the values are displayed in black).

### Embodiment 7

In a scanned image in which impairments (stripe patterns) by disturbance vibrations show up, once the disturbance frequencies can be identified, processing for removing the image impairments can be performed. This embodiment is described. FIG. 13(a1) is the same analysis image as FIG. 6(a1). FIGS. 13(b) and (b2) are display window screens that are its normalized power spectral image and its normalized power spectral graph, respectively, to which mask filters are applied. A “Band Mask” filter within the filter display frame below the screen is selected. The manner in which the positions of the wave numbers of the start and end of the mask filter are set is the same as the manner in which the positions of the wave numbers of the bandpass filter of Embodiment 5 are set. In the present embodiment, 31 that is a main disturbance wave number (×(1/256) pixel⁻¹) is noticed and a wave number band 19-51 containing it is masked. After the decision of the masked region, the power at the wave number of the masked band is set to 0 and subjected to inverse 1D-FFT to display a converted image. FIG. 13(a2) is the converted image. The converted image is a real-space image from which image impairments due to disturbance vibrations are removed.

In removal of image impairments, it is not necessary to find the disturbance frequency fₕ in Hz (=s⁻¹) of Embodiment 1. If the vibration wave numbers (in pixel⁻¹) are identified, image impairments can be removed.

### Embodiment 8

On a production line such as for semiconductor products and so on, plural SEMs 101-104 are connected via a network with a management master computer 105 for metrology management of semiconductor device patterns or the like as shown in FIG. 14. In each SEM, a computing function based on the above-described analysis method of disturbance vibrations is incorporated in the computer of the control processor of the SEM and disturbance vibrations can be self-evaluated under instructions from the operator of the apparatus. The evaluated values of the disturbance vibrations are displayed using an image display device on which a microscope image is displayed. Also, in SEMs used for long-term metrology management of device patterns or the like, each SEM analyzes and evaluates disturbance vibrations periodically using a sample (such as a microscale sample) for analysis of disturbance vibrations and displays and records the vibrations together with transitional information about the evaluated values of them. The periodical evaluated values of disturbance vibrations are picked up by the master computer 105, where the values and information from other SEMs are collectively managed. Where the evaluated value of the disturbance vibration (normalized power spectrum) is in excess of a preset tolerable range, the operator of the apparatus is informed of the abnormality in that SEM and also in the master computer 105. The master computer 105 is equipped with an image display monitor 106 and with a control processor as described above. The fact that the evaluated value of the disturbance vibration has exceeded the preset tolerable range is displayed on the image display monitor 106. A specific form of display may consist of overlapping a transition of an evaluated value of disturbance vibrations (normalized power spectrum) on a normalized power spectral graph in which a preset tolerable range (threshold value spectrum) as shown in FIG. 12 has been written for each SEM, discriminating a spectrum where wave numbers falling outside the tolerable range appear from spectra where wave numbers are within the tolerable range and displaying the spectrum, and discriminating the graph itself of the corresponding SEM from the graph of the SEM having only a spectrum falling within the tolerable range and displaying it. Alternatively, plural SEMs may be displayed as models as shown in FIG. 14 and a specific SEM model may be flickered when powers go outside the preset tolerable range or set values. By providing display in this way, diurnal change of each inspection apparatus and the differences between apparatuses can also be managed. When an abnormality is discerned, a disturbance factor is identified based on the analyzed disturbance frequency and work for eliminating the factor is performed.

In the above embodiment, the master computer 105 picks up evaluated values of a disturbance vibrations from each apparatus. The master computer 105 may pick up images for analyzing disturbance vibrations from each apparatus and analyses of the disturbance vibrations may be performed on the side of the master computer 105. On the side of each apparatus, the work time for the analysis of disturbance vibrations can be passed to other work time. In busy cases, this is effective in that the inspection throughput is not deteriorated.

Embodiments of scanning electron microscopes (SEMs) have been described so far. Similar advantageous effects can be obtained with a scanning transmission electron microscope (STEM) and a scanning ion microscope (SIM). That is, any apparatus can yield the advantageous effects of the present invention as long as it is a microscope using a scanning beam made of focused charged particles. Furthermore, a 1D-FFT (or 1D-DFT) analysis is used to identify the vibration frequencies of external disturbances. The invention can also be applied to cases where observations using a scanning charged particle microscope are employed in identifying the natural frequencies or excitation frequencies of single parts or composites fabricated by microfabrication technology or the like.

### REFERENCE SIGNS LIST

1: electron gun
2: electrons
3: condenser lens
4: objective lens
5: sample
6: deflector
7: secondary electrons
8: charged particle detector
9: control processor
10: display means
11: 1D-FFT analysis means

1. A method for analysis of image vibrations in a part or the whole of a scanned image of charged particles, comprising the step of:
analyzing said image vibrations by a one-dimensional fast Fourier transform (1D-FFT) or one-dimensional discrete Fourier transform (1D-DFT) in any one of a direction (X direction) along which a rectangular image of the whole or a part of said scanned image is scanned with the charged particles and a direction (Y direction) perpendicular to said direction.

2. The method for analysis of image vibrations as set forth in claim 1, wherein a 1D-FFT or 1D-DFT power spectral image is used by the one-dimensional fast Fourier transform (1D-FFT) or one-dimensional discrete Fourier transform (1D-DFT) in the direction (X direction) along which the rectangular image of the whole or a part of said scanned image is scanned with the charged particles or the direction perpendicular to said direction.

3. The method for analysis of image vibrations as set forth in claim 2, wherein a 1D-FFT (or 1D-DFT) power spectral graph obtained by averaging power spectral intensities of said 1D-FFT (or 1D-DFT) power spectral image in a direction perpendicular to a direction of said 1D-FFT (or 1D-DFT) is used.

4. The method for analysis of image vibrations as set forth in claim 2, wherein vibration frequencies (in s⁻¹ or Hz) converted from wave numbers (in pixel⁻¹) of said image vibrations using a scanning speed (in pixel/s) of said charged particles are used.

5. A scanning charged particle microscope comprising:
a source of charged particles;
a detector for detecting secondary particles emitted by irradiating a sample with a focused beam of charged particles emitted from said source of charged particles; and
a control processor for forming an image based on an output of said detector;
in which said control processor creates at least one of a power spectral image and a power spectral graph of a 1D-FFT (or 1D-DFT) in any one of a direction (X direction) along which a rectangular image of the whole or a part of said scanned image is scanned with the charged particles and a direction (Y direction) perpendicular to said direction.

6. The scanning charged particle microscope as set forth in claim 5, wherein said control processor converts wave numbers (in pixel⁻¹) in at least one of a power spectral image and a power spectral graph of said 1D-FFT (or 1D-DFT) into vibration frequencies (in s⁻¹ or Hz) using a scanning speed (in pixel/s) of said charged particles.

7. The scanning charged particle microscope as set forth in claim 5, wherein said control processor periodically calculates at least one of a power spectral image and a power spectral graph of said 1D-FFT (or 1D-DFT) and displays or stores said calculated evaluated power spectral image or evaluated power spectral graph together with diurnal transition information.

8. The scanning charged particle microscope as set forth in claim 7, wherein:
there is provided a function of setting a threshold value power spectrum in a power spectral graph of said 1D-FFT (or 1D-DFT); and,
when said evaluated power spectrum exceeds said threshold value power spectrum, its occurrence is displayed on display means or stored.

9. The scanning charged particle microscope as set forth in claim 5, wherein said control processor has a function of storing a natural mechanical resonant frequency or electrical frequency of said scanning charged particle microscope, identifies a disturbance frequency corresponding to a disturbance vibration in said scanned image using at least one of a power spectral image and a power spectral graph of said 1D-FFT (or 1D-DFT), compares said disturbance frequency with said natural vibration frequency of the apparatus, and displays said disturbance frequency.

10. The scanning charged particle microscope as set forth in claim 5, wherein said control processor identifies wave numbers of disturbance vibrations in said scanned image using at least one of a power spectral image and a power spectral graph of said 1D-FFT (or 1D-DFT), removes power at said wave numbers from said power spectrum, and subjecting said power spectral from which the power is removed to an inverse 1D-FFT (or 1D-DFT) to create a real-space image.

11. A computer for analysis of image vibrations for analyzing image vibrations of images based on said images obtained from a plurality of scanning charged particle microscopes via a network,
in which said computer for analysis of image vibrations analyzes said image vibrations by a one-dimensional fast Fourier transform (1D-FFT) or one-dimensional discrete Fourier transform (1D-DFT) in any one of a direction (X direction) along which a rectangular image of the whole or a part of said scanned image is scanned with the charged particles and a direction (Y direction) perpendicular to said direction.

12. The computer for analysis of image vibrations as set forth in claim 11, wherein the computer for analysis of image vibrations uses at least one of:
a power spectral image of said 1D-FFT (or 1D-DFT) having
a power spectral intensity of said 1D-FFT (or 1D-DFT) as a brightness signal,
wave numbers of said 1D-FFT as a lateral-axis (or vertical-axis) signal, and
a direction perpendicular to the direction of said 1D-FFT (or 1D-DFT) as a vertical-axis (or lateral-axis) signal; and
a power spectral graph obtained by averaging in a direction perpendicular to the direction of said 1D-FFT (or 1D-DFT),

13. The computer for analysis of image vibrations as set forth in claim 12, wherein vibration frequencies (in s⁻¹ or Hz) converted from wave numbers (in pixel⁻¹) of said image vibrations using a scanning speed (in pixel/s) of said charged particles are used.

14. The computer for analysis of image vibrations as set forth in claim 13, wherein said computer for analysis of image vibrations periodically calculates at least one of a power spectral image and a power spectral graph of said 1D-FFT (or 1D-DFT) and displays or stores said calculated evaluated power spectral image or evaluated power spectral graph together with diurnal transition information.

15. The computer for analysis of image vibrations as set forth in claim 13, wherein:
there is provided a function of setting a threshold value power spectrum in a power spectral graph of said 1D-FFT (or 1D-DFT) for each scanning charged particle microscope; and,
when said evaluated power spectrum exceeds said threshold value power spectrum, its occurrence is displayed on display means or stored.

16. The computer for analysis of image vibrations as set forth in claim 14, wherein said computer for analysis of image vibrations has a function of storing a natural mechanical resonant frequency and an electrical frequency of each individual apparatus of scanning charged particle microscope, identifies in a specific scanning charged particle microscope a disturbance vibration frequency corresponding to a disturbance vibration in said scanned image from the scanned image using at least one of a power spectral image and a power spectral graph of said 1D-FFT (or 1D-DFT), compares said disturbance frequency with the natural vibration frequency of the apparatus of said specific scanning charged particle microscope, and displays said disturbance frequency.
